(19) United States
(12) Patent Application Publication
(10) Pub. No.: US 2010/0097427 A1
(43) Pub. Date: Apr. 22, 2010

(54) LIQUID EJECTING HEAD AND LIQUID EJECTING APPARATUS

(75) Inventor: Hiroshige Owaki, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/580,969

(22) Filed: Oct. 16, 2009

(30) Foreign Application Priority Data
Oct. 21, 2008 (JP) 2008-271388

(51) Int. Cl. B41J 2/14

(52) U.S. Cl. 347/50

(57) ABSTRACT

A liquid ejecting head includes: a fluid channel formation substrate in which a fluid channel is formed so as to be communicated to a nozzle opening for ejecting liquid; a pressure generating element which applies pressure on the liquid to be ejected; a first substrate of which one end is electrically connected to the pressure generating element; a second substrate which is connected to the other end of the first substrate; and a support unit which supports the first substrate. Here, the support unit includes an erecting section which is provided on the one end of the first substrate, and a substrate support section which is provided on a side of the erecting section facing the second substrate and is formed of a separate member from the erecting section. The substrate support section includes a connection support surface on a side thereof facing the second substrate. In addition, a connection portion between the first substrate and the second substrate is disposed on a position facing the connection support surface.

### BACKGROUND

1. Technical Field

The present invention relates to a liquid ejecting head and a liquid ejecting apparatus, and more particularly, to a liquid ejecting head and a liquid ejecting apparatus which are useful to be applied to an ink jet recording head ejecting ink as liquid.

2. Related Art

As a typical example of a liquid ejecting head which ejects liquid droplets, an ink jet recording head which ejects ink droplets is exemplified. As the ink jet recording head, for example, there has been known an ink jet recording head that is provided with a fluid channel formation substrate which forms a fluid channel including a pressure generating chamber which is connected to a nozzle opening, a piezoelectric element that is formed on the fluid channel formation substrate, and a protection substrate that is bonded to the surface of the fluid channel formation substrate on which the piezoelectric element is mounted and has a piezoelectric element holding portion for holding the piezoelectric element. Here, as such an ink jet recording head, there has been known an ink jet recording head in which a driving circuit for applying a driving voltage to drive the piezoelectric element is connected to the piezoelectric element via a lead electrode drawn out from one electrode of the piezoelectric element, in which the connection is made by a wire bonding method using a connection wiring made of a conductive wire (for example, refer to JP-A-2004-148813).

However, in the configuration as described in JP-A-2004-148813, since the electrical connection is performed using the wire bonding method, it causes soaring costs and there is a problem in that it is difficult to increase density.

Further, such a problem also exists in a liquid ejecting head which ejects liquid other than ink as well as the ink jet recording head which ejects ink.

### SUMMARY

An advantage of some aspects of the invention is to provide a liquid ejecting head and a liquid ejecting apparatus which can achieve a reduction in production cost and easily achieve an increase in density.

According to an aspect of the invention, there is provided a liquid ejecting head which includes: a fluid channel formation substrate in which a fluid channel is formed so as to be communicated to a nozzle opening for ejecting liquid; a pressure generating element which applies pressure on the liquid to be ejected; a first substrate of which one end is electrically connected to the pressure generating element; a second substrate which is connected to the other end of the first substrate; and a support unit which supports the first substrate. Here, the support unit includes an erecting section which is provided on the one end of the first substrate, and a substrate support section which is provided on a side of the erecting section facing the second substrate and is formed of a separate member from the erecting section. The substrate support section includes a connection support surface on a side thereof facing the second substrate. In addition, a connection portion between the first substrate and the second substrate is disposed in a position facing the connection support surface.

In the liquid ejecting head, since the electrical connection to the pressure generating element is carried out by the first substrate, it is possible to easily achieve a reduction in the production cost compared with a wire bonding method, and it is also possible to easily achieve high density. In addition, since the connection portion between the first substrate and the second substrate is disposed on the connection support surface, that is, the connection portions of both substrates are positioned on the connection support surface, the connection between both substrates can be easily and favorably carried out, and the reliability of the product can be improved.

In the liquid ejecting head, it is preferable that a connection line which is electrically connected to the pressure generating element and connected to one end of the first substrate be further included. In addition, it is preferable that the support unit be provided in a position facing a connection portion between the first substrate and the connection line. According to this configuration, with the connection line, the connection between the pressure generating element and the first substrate can be easily and favorably carried out. Therefore, the reliability of the product can be further improved.

In the liquid ejecting head, it is preferable that an area of the connection support surface be larger than that of a surface of the erecting section facing the fluid channel formation substrate. According to this configuration, a large connection support surface can be ensured without increasing the area of the head, and the connection between the first substrate and the second substrate can be favorably carried out. Therefore, the reliability of the product can be further improved.

In the liquid ejecting head, it is preferable that positioning convex portions be provided on the connection support surface, and positioning concave portions be each provided on the first substrate and the second substrate. In addition, it is preferable that the positioning convex portions and the positioning concave portions be engaged with each other, so that the first substrate and the second substrate are positioned with respect to the support unit. According to this configuration, since the first substrate and the second substrate are positioned with accuracy by the positioning convex portions and the positioning concave portions, the connection between the first substrate and the second substrate can be further favorably and accurately carried out.

In the liquid ejecting head, it is preferable that a boss portion be provided on the connection support surface so as to protrude from the connection support surface. According to this configuration, the boss portion is used to erect the support unit, so that the support unit can be erected without contact with the first substrate.

In the liquid ejecting head, it is preferable that the erecting section and the substrate support section be plate-like members, and the first substrate be supported along the support unit. Since the first substrate is not widened in the area direction of the head, it is possible to prevent the head itself from increasing in size.

According to another aspect of the invention, there is provided a liquid ejecting apparatus which is provided with the liquid ejecting head. According to the invention, the liquid ejecting apparatus can exhibit the above-mentioned operations and effects.

### BRIEF DESCRIPTION OF THE DRAWINGS

The invention will be described with reference to the accompanying drawings, wherein like numbers reference like elements.

FIG. 1 is an exploded perspective view illustrating a recording head according to a first embodiment.

FIG. 2A is a plan view illustrating the recording head according to the first embodiment.

FIG. 2B is a cross-sectional view illustrating the recording head according to the first embodiment.

FIG. 3 is a cross-sectional view illustrating the recording head according to the first embodiment.

FIG. 4 is a cross-sectional view illustrating the recording head according to the first embodiment.

FIG. 5 is a cross-sectional view illustrating the recording head according to the first embodiment.

FIG. 6 is a cross-sectional view illustrating a recording head according to a second embodiment.

FIG. 7 is an exploded perspective view illustrating a recording head according to a third embodiment.

FIG. 8A is a plan view illustrating the recording head according to the third embodiment.

FIG. 8B is a cross-sectional view illustrating the recording head according to the third embodiment.

FIG. 9 is an exploded perspective view illustrating a recording head according to a fourth embodiment.

FIG. 10A is a plan view illustrating the recording head according to the fourth embodiment.

FIG. 10B is a cross-sectional view illustrating the recording head according to the fourth embodiment.

FIG. 11 is a cross-sectional view illustrating a recording head according to another embodiment.

FIG. 12 is a perspective view illustrating a printer with the recording head.

### DESCRIPTION OF EXEMPLARY EMBODIMENTS

In the following, embodiments of the invention will be described in detail with reference to the accompanying drawings.

### First Embodiment

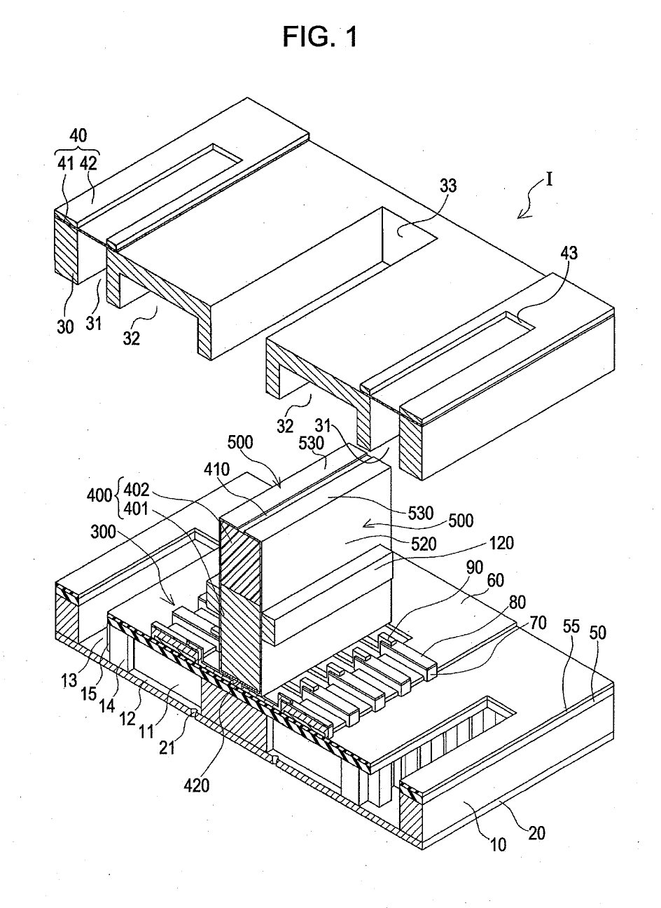

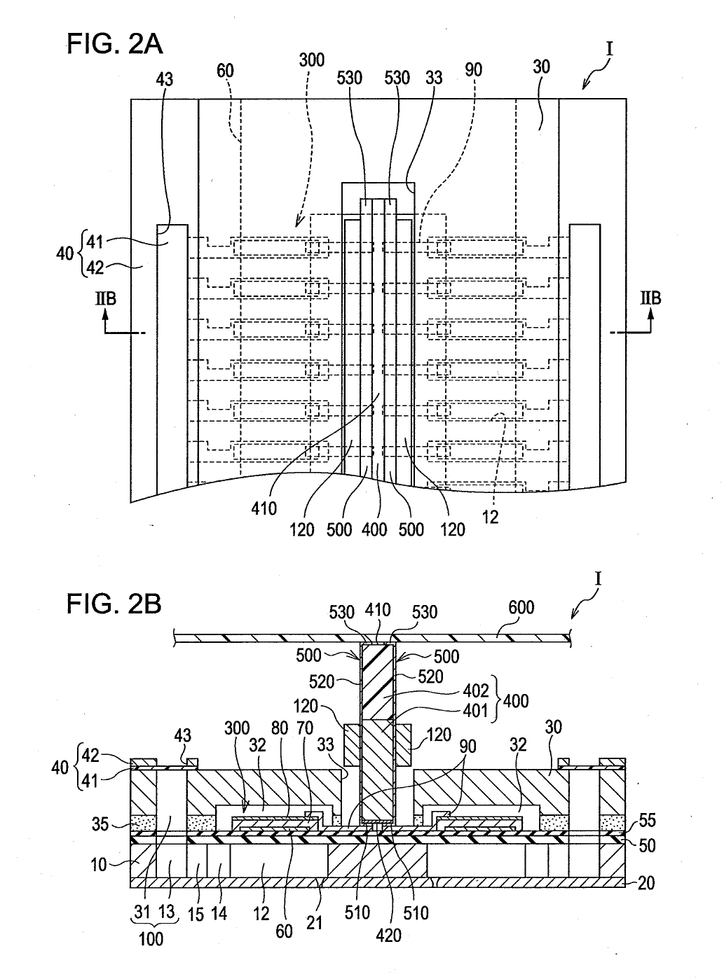

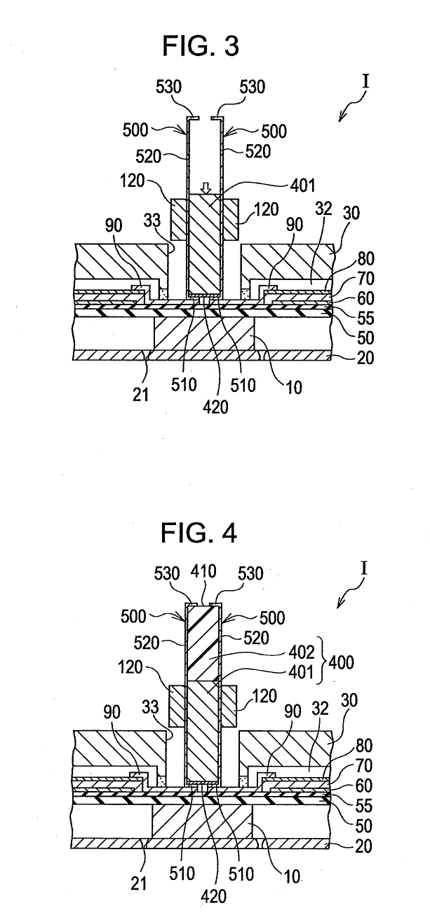

FIG. 1 is an exploded perspective view schematically illustrating a configuration of an ink jet recording head which is an example of a liquid ejecting head according to a first embodiment of the invention. FIG. 2A is a plan view of FIG. 1, and FIG. 2B is a cross-sectional view taken along a line IIB-IIB of FIG. 2A. Further, in FIG. 1, a flexible printed substrate to be described later is omitted. In addition, FIGS. 3 to 5 are expanded cross-sectional views illustrating a part of the ink jet recording head according to the embodiment.

A fluid channel formation substrate 10 is made of a silicon single-crystal substrate of a plane orientation (110) in this embodiment, and as shown in the drawing, a silicon dioxide elastic film 50 is formed on one surface thereof.

In the fluid channel formation substrate 10, plural pressure generating chambers 12 are provided in two columns such that they are provided in parallel with each other in a width direction thereof. In addition, a communication portion 13 is provided in an outside region of each pressure generating chamber 12 in a longitudinal direction, and the communication portion 13 is communicated with each pressure generating chamber 12 via an ink supply passage 14 and a communication passage 15 which are provided at each pressure generating chamber 12. The communication portion 13 is communicated with a reservoir portion 31 of a protection substrate 30 to be described later, so that it configures a part of a reservoir 100 which is a common ink chamber for each column of the pressure generating chamber 12. The ink supply passage 14 is formed with a width smaller than that of the pressure generating chamber 12, and constantly maintains fluid channel resistance of ink which flows into the pressure generating chamber 12 from the communication portion 13. Further, in this embodiment, the ink supply passage 14 is formed such that the width of the fluid channel becomes narrower from one side thereof, but the ink supply passage may be formed such that the width of the fluid passage becomes narrower from both sides thereof. In addition, the ink supply passage may be formed such that the width of the fluid channel is not narrowed but the fluid channel is narrowed in a thickness direction. Furthermore, each communication passage 15 is formed such that partition walls 11 on both sides of the pressure generating chamber 12 in a width direction are extended to the communication portion 13 so as to partition a space between the ink supply passage 14 and the communication portion 13. That is, in the fluid channel formation substrate 10, the ink supply passage 14, which has a sectional area smaller than that of the pressure generating chamber 12 in a width direction, and the communication passage 15, which is communicated with the ink supply passage 14 and has a sectional area larger than that of the ink supply passage 14 in a width direction, are partitioned by plural partition walls 11.

In addition, nozzle openings 21 for communication are bored in a nozzle plate 20 in the vicinity of the end portion of each pressure generating chamber 12 opposite to the ink supply passage 14. The nozzle plate 20 is fixed on the side of the fluid channel formation substrate 10, in which the openings are formed, by an adhesive, a heat welding film, or the like. In this embodiment, since the pressure generating chambers 12 are arranged on the fluid channel formation substrate 10 in two columns, there are provided nozzle arrays in which the nozzle openings 21 are provided in parallel with each other, in one ink jet recording head I. Further, the nozzle plate 20 is made of, for example, glass ceramics, a silicon single-crystal substrate, a stainless steel, or the like.

On the other hand, as described above, the elastic film 50 is formed on the surface side of the fluid passage formation substrate 10 opposite to the surface in which the openings are formed. An insulator film 55 is formed on the elastic film 50. In addition, a lower electrode film 60, a piezoelectric layer 70, and an upper electrode film 80 are laminated on the insulator film 55, so that a piezoelectric element 300 is configured. Here, the piezoelectric element 300 corresponds to a portion including the lower electrode film 60, the piezoelectric layer 70, and the upper electrode film 80. In general, any one of the electrodes of the piezoelectric element 300 is used as a common electrode, and the other electrode and the piezoelectric layer 70 are patterned for each pressure generating chamber 12. Here, the portion, which is configured of the patterned electrode and the patterned piezoelectric layer 70 and generates piezoelectric deformation by applying a voltage on both electrodes, is referred to as a piezoelectric active section. In this embodiment, the lower electrode film 60 is used as the common electrode of the piezoelectric element 300 and the upper electrode film 80 is used as a separate electrode of the piezoelectric element 300, but there will be no problem even though the use thereof is reversed in a case of a driving circuit or a wiring.

Here, the piezoelectric element 300 and an oscillation plate, which is deformed by the driving of the corresponding piezoelectric element 300, are together referred to as an actuator device. The actuator device configures a pressure generating element which is formed to apply pressure on the pressure generating chamber 12 so as to eject liquid. Further, in the embodiment as described above, the elastic film 50, the insulator film 55, and the lower electrode film 60 operate as the oscillator plate, but the invention is not limited thereto. For example, instead of providing the elastic film 50 and the insulator film 55, only the lower electrode film 60 may operate as the oscillation plate. In addition, the piezoelectric element 300 itself may also actually serve as the oscillation plate. In this embodiment, the piezoelectric elements 300 are provided in parallel with each other in two columns corresponding to the respective pressure generating chamber 12.

The piezoelectric layer 70 is made of a piezoelectric material which is formed on the lower electrode film 60 and shows an electromechanical transducing operation, and in particular, is made of a ferroelectric material in a perovskite structure among the piezoelectric materials. The piezoelectric layer 70 preferably uses a crystal film in the perovskite structure. For example, a ferroelectric material such as lead zirconium titanate (PZT) and a material obtained by adding a metal oxide such as niobium oxide, nickel oxide, or magnesium oxide to the ferroelectric material are suitable for the material of the piezoelectric layer. Specifically, lead titanate (PbTiO₃), lead zirconium titanate (Pb(Zr, Ti)O₃), lead lanthanum titanate ((Pb, La), TiO₃), lead zirconium (PbZrO₃), lead lanthanum zirconate titanate ((Pb, La)(Zr, Ti)O₃), or lead magnesium niobate zirconium titanate (Pb(Zr, Ti)(Mg, Nb)O₃) can be used. A thickness of the piezoelectric layer 70 is formed such that the thickness is suppressed to a degree so as not to generate cracks in manufacturing processes and is thick enough that deformation characteristics are sufficiently exhibited.

In addition, lead electrodes 90 are electrically connected to each of the upper electrode films 80 which are the separate electrodes of the piezoelectric elements 300. The lead electrode 90 are each drawn out from the vicinity of the end of the upper electrode film 80 opposite to the ink supply passage 14 and extend up to the insulator film 55. The lead electrode 90 is a connection line made of, for example, gold (Au) or the like.

On the fluid channel formation substrate 10 on which the piezoelectric element 300 is formed, that is, on the lower electrode film 60, the elastic film 50, and the lead electrode 90, the protection substrate 30 which has the reservoir portion 31 configuring at least a part of the reservoir 100 is bonded via an adhesive 35. The reservoir portion 31 passes through the protection substrate 30 in a thickness direction and formed to the pressure generating chamber 12 in a width direction. In addition, the reservoir portion 31 is communicated with the communication portion 13 of the fluid channel formation substrate 10, so that the reservoir 100 is configured so as to become the common ink chamber for each pressure generating chamber 12. In addition, the communication portion 13 of the fluid channel formation substrate 10 is divided into plural pieces for each pressure generating chamber 12, so that only the reservoir portion 31 may be configured as the reservoir. Furthermore, for example, only the pressure generating chamber 12 may be provided on the fluid channel formation substrate 10, and the ink supply passage 14 communicating the reservoir and each pressure generating chamber 12 may be provided on a member (for example, the elastic film 50, the insulator film 55, etc.) which is interposed between the fluid channel formation substrate 10 and the protection substrate 30.

In addition, a piezoelectric element holding portion 32 is provided in the region of the protection substrate 30 facing the piezoelectric element 300, which includes a space having a size so as not to hinder the oscillation of the piezoelectric element 300. It is sufficient that the piezoelectric element holding portion 32 includes a space sufficient enough not to hinder the oscillation of the piezoelectric element 300, and the space may also be sealed or not sealed.

In addition, a through hole 33 is provided in the protection substrate 30, which passes through the protection substrate 30 in a thickness direction. Here, in this embodiment, the piezoelectric elements 300 face each other and are provided in parallel with each other in two columns. The through hole 33 is continuously provided between the columns of the piezoelectric element 300 along an arrangement direction of the piezoelectric elements 300. In addition, the vicinity of the end of the lead electrode 90 which is drawn from each piezoelectric element 300 is provided so as to go into the through hole 33. Then, in the through hole 33, a COF substrate 500, which is a first substrate provided with lines, and a support unit 400, which supports the COF substrate 500 so as to erect from the fluid channel formation substrate 10, are inserted, which will be described later. Further, as shown in FIG. 2B, the end of the COF substrate 500 facing the lead electrode 90 is connected to the lead electrode 90 and the end of the COF substrate 500 opposite to the lead electrode 90 is connected to a flexible printed substrate 600 which is a second substrate. As described above, by interposing the lead electrode 90, the connection between the piezoelectric element 300 and the COF substrate 500 can be easily and favorably carried out, and product reliability can be further improved. In addition, a driving circuit 120 is mounted on the COF substrate 500 so as to apply a driving voltage to the piezoelectric element 300.

As the protection substrate 30, a material with approximately same rate of thermal expansion as that of the fluid channel formation substrate 10 (for example, a glass material, a ceramic material, etc.) is preferably used. In this embodiment, the protection substrate 30 is formed using a silicon single-crystal substrate made of the same material as that of the fluid channel formation substrate 10.

In addition, a compliance substrate 40 is connected on the protection substrate 30, which is configured with a sealing film 41 and a fixing plate 42. Here, the sealing film 41 is formed of a flexible material (for example, a polyphenylene sulfide (PPS) film) of which rigidity is low, and one surface of the reservoir portion 31 is sealed by the sealing film 41. In addition, the fixing plate 42 is formed of a hard material such as a metal (for example, stainless steel (SUS), etc.). The region of the fixing plate 42 facing the reservoir 100 is formed of an opening 43 which is provided by completely removing the fixing plate in the thickness direction, and one surface of the reservoir 100 is sealed only by the flexible sealing film 41.

Here, the support unit 400, the COF substrate 500, and the flexible printed substrate 600 will be described.

The support unit 400 is a member for supporting the COF substrate 500 so as to erect the COF substrate 500 from the fluid channel formation substrate 10. The support unit 400 is provided with a plate-like erecting section 401 which is provided on the end side of the COF substrate 500 connected to the piezoelectric element 300, and a plate-like substrate support section 402 which is a separate member from the erecting section 401 and is provided on the erecting section 401 facing the flexible printed substrate 600. More specifically, the erecting section 401 is a plate-like member which is provided on the surface of the fluid channel formation substrate 10 facing the lead electrode 90, and the substrate support section 402 is a separate member from the erecting section 401 and provided on the side of the erecting section 401 opposite to the fluid channel formation substrate 10. In addition, as described above, the lower end portion of the support unit 400 is inserted into the through hole 33 of the protection substrate 30, and the support unit 400 is provided in a position on the fluid channel formation substrate 10 in which the COF substrate 500 faces the lead electrode 90. Further, the erecting section 401 and the substrate support section 402 according to this embodiment are the plate-like members of which the planar shapes are equal. In addition, a convex portion and a concave portion facing each other are provided on the surface of the erecting section 401 facing the substrate support section 402 and the surface of the substrate support section 402 facing the erecting section 401, but are not shown in the drawing. When the substrate support section 402 is placed on the erecting section 401, the convex portion and the concave portion are engaged so as not to deviate from each other. In addition, the substrate support section 402 includes a planar shaped connection support surface 410 on the surface thereof facing the flexible printed substrate 600, that is, the surface of the substrate support section 402 opposite to the erecting section 401. The connection support surface 410 serves as a support when the COF substrate 500 and the flexible printed substrate 600 are connected to each other, which will be described later, so that the connection support surface 410 is preferably formed to be a planar surface. The connection support surface 410 according to this embodiment is parallel to a surface direction of the surface, on which the piezoelectric element 300 of the fluid channel formation substrate 10 is provided, and is formed to be a planar surface. Then, the COF substrates 500 are each supported on both surfaces of the support unit 400.

The COF substrate 500 is a flexible substrate on which lines (not shown) are provided. The COF substrates 500 are disposed on both surfaces of the support unit 400 one by one in a state where the lines face outside.

Here, the end (hereinafter, referred to as a lower end portion 510) of the COF substrate 500 facing the fluid channel formation substrate 10 is bent in a direction toward the surface of the erecting section 401 facing the fluid channel formation substrate 10. In this embodiment, a cushion member 420, which can be appropriately formed by Teflon (Registered Trademark) or the like, is disposed between the lower end portion 510 of the COF substrate 500 and the surface of the erecting section 401 facing the fluid channel formation substrate 10. Then, the lower end portion 510 of the COF substrate 500 is electrically and mechanically connected to the lead electrode 90 via a conductive adhesion layer. Here, the conductive adhesion layer can be appropriately formed by an anisotropic conductive agent such as a solder, an anisotropic conductive film (ACF), and an anisotropic conductive paste (ACP). The conductive adhesion layer of this embodiment is configured with the anisotropic conductive paste with conductive particles, and the support unit 400 is pushed to the fluid channel formation substrate 10, so that the support unit 400 is erected and provided on the fluid channel formation substrate 10 and the COF substrate 500 is electrically connected to the lead electrode 90. At this time, the cushion member 420 acts so as to make uniform the pressing force applied on the lower end portion 510 of the COF substrate 500 and the lead electrode 90. That is, with the configuration of this embodiment, the lead electrode 90 and the lower end portion 510 of the COF substrate 500 are uniformly pressed by the cushion member 420, so that the electrical connection can be favorably performed. Here, it is preferable that the surface accuracy of the surface of the erecting section 401 facing the fluid channel formation substrate 10 and the lower end portion 510 of the COF substrate 500, or the surface accuracy of the surface of the erecting section 401, with which the cushion member 420 comes into contact, facing the fluid channel formation substrate 10 be less than 5 times the particle diameter of the conductive particles in the anisotropic conductive agent. As a result, by depending also on the existence of the cushion member 420, it is possible to make uniform the pressing force urged on the conductive particles via the lower end portion 510 of the COF substrate 500, and by reliably pushing the conductive particles, so that electrical connection is favorably ensured.

On the other hand, the other end (hereinafter, referred to as an upper end portion 530) of the COF substrate 500 opposite to the fluid channel formation substrate 10 is bent in a direction toward the connection support surface 410 of the substrate support section 402, and comes into contact with the connection support surface 410 so as to be supported thereby. Further, the upper end portions 530 of two sheets of the COF substrates 500 are supported by the connection support surface 410 in a state where the upper end portions are separated from each other by a predetermined distance.

In addition, a middle portion 520, which corresponds to the other portion of the lower end portion 510 and the upper end portion 530 of the COF substrate 500, comes into contact with the side surface of the support unit 400 so as to be supported thereto. In this embodiment, the middle portion 520 corresponding to the erecting section 401 is bonded to the side surface of the erecting section 401. In this way, since the middle portion 520 is supported by the support unit 400, the COF substrate 500 is provided so as to be erected from the fluid channel formation substrate 10 along the support unit 400. Further, the connection between the erecting section 401 and the COF substrate 500 is preferably performed using an ultraviolet cure adhesive or an instant adhesive. In addition, on the middle portion 520 of the COF substrate 500, driving circuits 120 are mounted on opposite surfaces of the support unit 400 in order to apply a driving voltage on the piezoelectric elements 300. The driving circuits 120 are connected to the piezoelectric elements 300.

The flexible printed substrate 600 is a flexible substrate, on which lines (not shown) are provided, and which is connected to external devices such as sensors (not shown). The flexible printed substrate 600 is connected to the upper end portion 530 of the COF substrate 500. That is, the connection portion between the COF substrate 500 and the flexible printed substrate 600 is disposed in a position facing the connection support surface 410. Here, in this embodiment, the upper end portion 530 of the COF substrate 500 comes into contact with the connection support surface 410 so as to be supported thereby. More specifically, the connection support surface 410 is sufficient to serve as a support of both substrates when the COF substrate 500 is connected with the flexible printed substrate 600, so that there may be no need for the upper end portion 530 of the COF substrate 500 to come into contact with the connection support surface 410, but it can be separated from the connection support surface 410.

Here, a material of the erecting section 401 of the support unit 400 is not particularly limited. For example, when the driving circuits 120 coming into contact therewith via the COF substrate 500 are ensured with good thermal radiation performance, the material with high thermal conductivity, for example, a metal material such as stainless steel (SUS), is preferable. That is, the driving circuits 120 are mounted on the opposite surfaces of the support unit 400 in the middle portion 520 of the COF substrate 500, that is, the surface facing the outer space, and heat generated from the driving circuits 120 is radiated to the outer space. However, it is more preferable that the erecting section 401 be formed of a material with high thermal conductivity, because the heat generated from the driving circuits 120 can be favorably conducted also to the fluid channel formation substrate 10 and furthermore the heat can be absorbed into the ink. In addition, when the substrate support section 402 is formed also of the material with high thermal radiation performance as well as the erecting section 401, the heat generated from the driving circuits 120 can be still more preferably radiated.

On the contrary, when the substrate support section 402 is manufactured with a material with low thermal radiation performance, the thermal radiation performance of the connection support surface 410 is also lowered, so that the connection between the COF substrate 500 and the flexible printed substrate 600 can be performed by a soldering scheme which is an electrical connection method generally performed at a low cost and widely carried out. Therefore, production cost can be lowered. In particular, by manufacturing the substrate support section 402 with a resin material which costs less than the metal material and has lower thermal radiation performance, it can also achieve a reduction in product price. In this embodiment, the substrate support section 402 was manufactured using the resin material with low thermal radiation performance. As a result, the connection between the COF substrate 500 and the flexible printed substrate 600 can easily be carried out at low cost by a soldering scheme. Therefore, it can achieve a reduction in production cost and product price.

Here, a process of disposing the support unit 400, the COF substrate 500, and the flexible printed substrate 600 on the fluid channel formation substrate 10 will be described with reference to FIGS. 3 to 5 as examples.

First, in order to position the lead electrode 90 and the lines of the COF substrate 500 on a predetermined position when the erecting section 401 is erected and provided on the fluid channel formation substrate 10, that is, in order to connect the lead electrode 90 and the COF substrate 500 when the erecting section 401 is erected and provided on the fluid channel formation substrate 10, the COF substrate 500 is positioned and fixed on the erecting section 401, and the erecting section 401 and the COF substrate 500 are integrated with each other into one unit. At this time, the COF substrate 500 is fixed by bonding the middle portion 520 corresponding to the erecting section 401 to the side surface of the erecting section 401.

Next, an electrically conductive adhesive is coated on the lower end portion 510 of the COF substrate 500 or the lead electrode 90 in the through hole 33. As shown in FIG. 3, the erecting section 401 and the COF substrate 500, which are integrated with each other, are pushed to the fluid channel formation substrate 10 so as to be erected and provided on the fluid channel formation substrate 10, and the lead electrode 90 is connected to the lower end portion 510 of the COF substrate 500. Here, when the erecting section 401 and the COF substrate 500 are pushed to the fluid channel formation substrate 10, it is preferable that all of the surface of the erecting section 401 opposite to the fluid channel formation substrate 10 be pressed in order to press all of the connection surface between the lower end portion 510 of the COF substrate 500 and the lead electrode 90 at the same pressure. As a result, as shown in FIG. 3, the lower end portion 510 of the COF substrate 500 and the lead electrode 90 can be favorably connected.

Next, as shown in FIG. 4, the substrate support section 402 is placed on the erecting section 401. Further, since only the COF substrate 500 corresponding to the erecting section 401 of the middle portion 520 is bonded on the side surface of the erecting section 401, there is no problem when the substrate support section 402 is mounted. As a result, the connection support surface 410 is disposed so as to face the upper end portion 530 of the COF substrate 500.

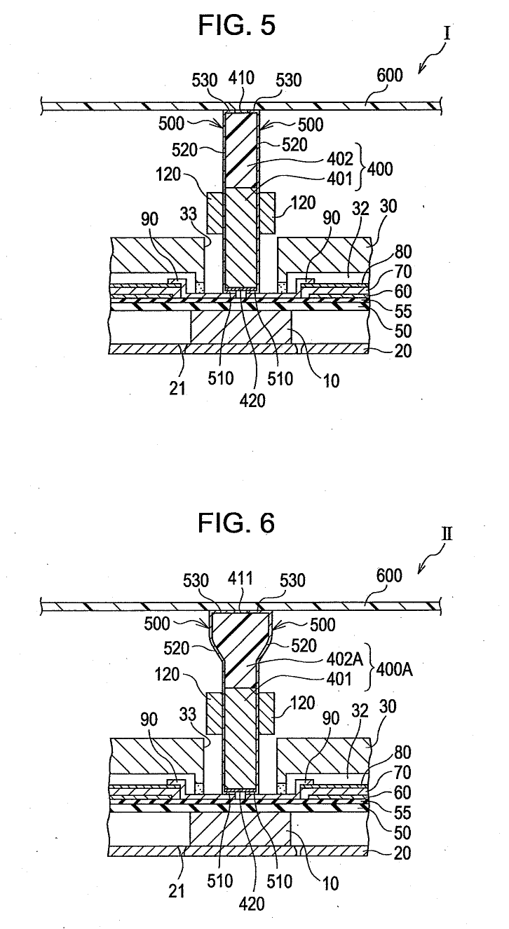

As shown in FIG. 5, the COF substrate 500 and the flexible printed substrate 600 are connected on the connection support surface 410. At this time, since the upper end portion 530 of the COF substrate 500 is provided in a position facing the connection support surface 410, a connection process of the COF substrate 500 and the flexible printed substrate 600 can be very easily and favorably carried out. That is, when there is no substrate support section 402, the connection portion between the COF substrate 500 and the flexible printed substrate 600 are separated from each other on the erecting section 401 so as to be in a floating state. When the pressing force is applied on both substrates to be connected in this floating state of the connection portion between both substrates, both substrates are deformed according to the pressing force so that there is hardly any of the connection process carried out. In addition, it can be considered that, when the connection process of the COF substrate 500 and the flexible printed substrate 600 is performed, a tool used as a support comes into contact with a rear surface of the connection portion of both substrates, and the connection between both substrates is carried out without providing the substrate support section 402 by using the tool as a support. However, since the tool should be also miniaturized in consideration of miniaturization, it is difficult to favorably carry out the connection process without ensuring rigidity of the tool. In addition, since the tool should be moved with accuracy in order not to damage the lines, a yield of products is also worsened.

In the configuration of this embodiment, since the substrate support section 402 is used as a support when both substrates are connected, the connection process of both substrates can be easily and favorably carried out. In particular, when plural ink jet recording heads are connected so as to be formed into one unit, the configuration according to the invention is employed, for example, the flexible printed substrate 600 is used as a common substrate to which the respective COF substrates 500 of plural heads are connected, so that it is possible to simplify the manufacturing processes and to significantly reduce the production cost and the product cost. Further, in the configuration as described above, the upper end portion 530 of the COF substrate 500 comes into contact with the connection support surface 410. However, since the connection support surface 410 is sufficient to be used as a support when the upper end portion 530 of the COF substrate 500 is being connected to the flexible printed substrate 600, the upper portion 530 of the COF substrate 500 may be slightly separated from the connection support surface 410. Further, when the connection portion of both substrates are slightly separated from the connection support surface 410, the separated distance is preferably set to the degree in which the connection process can be carried out. It is a matter of course that the distance is relatively determined according to the size of the ink jet recording head I to be implemented.

With the process as described above, the support unit 400, the COF substrate 500, and the flexible printed substrate 600 can be disposed on the fluid channel formation substrate 10. In particular, when the ink jet recording head I according to the embodiment is manufactured by the above-mentioned process, it is possible to favorably and easily carry out the connection between the COF substrate 500 and the flexible printed substrate 600 without damaging the lines. Here, when the support unit 400 is disposed on the fluid channel formation substrate 10, a method can be considered in which the erecting section 401 is pressed so as to be secured in an erecting state of the support unit 400 as shown in the above-mentioned process, and a method can be considered in which the substrate support section 402 is placed on the erecting section 401 and the substrate support section 402 is pressed so as to be secured in the erecting state of the support unit 400. In the former method, the position of the fluid channel formation substrate 10 closer than that of the latter method is pressed, and when being pressed, the erecting section 401 is difficult to fall over, so that it is possible to realize a reduction in the production yield.

In the ink jet recording head I according to this embodiment, after ink flows into an ink introduction hole which is connected to an external ink supply means (not shown) so as to fill with ink the inside portion from the reservoir 100 to the nozzle opening 21. According to the recording signal from the driving circuit 120, a voltage is applied across the lower electrode film 60 and the upper electrode film 80 which correspond to the pressure generating chamber 12. Then, the elastic film 50, the insulator film 55, the lower electrode film 60, and the piezoelectric layer 70 are flexibly deformed. Therefore, the pressure in each pressure generating chamber 12 increases, so that the ink droplets are ejected from the nozzle openings 21.

In the ink jet recording head I according to this embodiment as described above, since the electrical connection to the piezoelectric element 300 is carried out by the COF substrate 500, it is possible to easily achieve a reduction in the production cost compared with a wire bonding method, and it is also possible to easily achieve high density. In addition, since the connection portion between the COF substrate 500 and the flexible printed substrate 600 is disposed on the connection support surface 410, that is, the connection portions of both substrates are positioned on the connection support surface 410, the connection between both substrates can be easily and favorably carried out, and the reliability of the product can be improved. In particular, when plural ink jet recording heads are connected so as to be formed into one unit, the configuration according to the invention is employed, for example, the flexible printed substrate 600 is used as a common substrate to which the respective COF substrates 500 of plural heads are connected, so that it is possible to simplify the manufacturing processes and to significantly reduce the production cost and the product cost. In addition, when the process as described above is used for manufacturing, it is possible to favorably and easily carry out the connection between the COF substrate 500 and the flexible printed substrate 600 without damaging the lines.

In addition, in this embodiment, the support unit 400 is a plate-like member which is erected and provided on the fluid channel formation substrate 10, and the COF substrate 500 is supported so as to be erected from the fluid channel formation substrate 10 along the support unit 400. In such a configuration, since the COF substrate 500 is widened in an area direction of the head, it is possible to prevent an increase in size of the head itself.

### Second Embodiment

FIG. 6 is an enlarged cross-sectional view illustrating the support unit of the ink jet recording head according to a second embodiment of the invention. The ink jet recording head according to this embodiment shows a modified example with regard to the support unit portion, and the other portions are the same as those in the first embodiment. Here, the same components as those in the first embodiment are designated by the same reference numerals, and the description already given will be omitted.

As shown in the drawing, the support unit 400A of the ink jet recording head II according to this embodiment is provided with the erecting section 401 and the substrate support section 402A. In this embodiment, the area of the connection support surface 411 of the substrate support section 402A is formed to be larger than that of the surface of the erecting section 401 facing the fluid channel formation substrate 10. Specifically, in this embodiment, the length of the connection support surface 411 in the longitudinal direction of the piezoelectric element 300 is formed to be longer than that of the surface of the erecting section 401 facing the fluid channel formation substrate 10 in the longitudinal direction of the piezoelectric element 300. Therefore, the area of the connection support surface 411 is larger than that of the surface of the erecting section 401 facing the fluid channel formation substrate 10.

As described above, since the area of the connection support surface 411 is formed to be larger than that of the surface of the erecting section 401 facing the fluid channel formation substrate 10, a large area of the connection support surface 411 is ensured even though the size of the head itself is not increased, so that the connection between the COF substrate 500 and the flexible printed substrate 600 can be further preferably carried out. Therefore, product reliability can be further improved.

Further, in this embodiment, the length of the connection support surface 411 in the longitudinal direction of the piezoelectric element 300 is formed to be larger than that of the surface of the erecting section 401 facing the fluid channel formation substrate 10 in the longitudinal direction of the piezoelectric element 300. Therefore, the area of the connection support surface 411 is formed to be larger than that of the surface of the erecting section 401 facing the fluid channel formation substrate 10. However, for example, the length of the connection support surface along the arrangement direction of the piezoelectric elements 300, so that the area of the connection support surface 411 may be formed to be larger than that of the surface of the erecting section 401 facing the fluid channel formation substrate 10.

### Third Embodiment

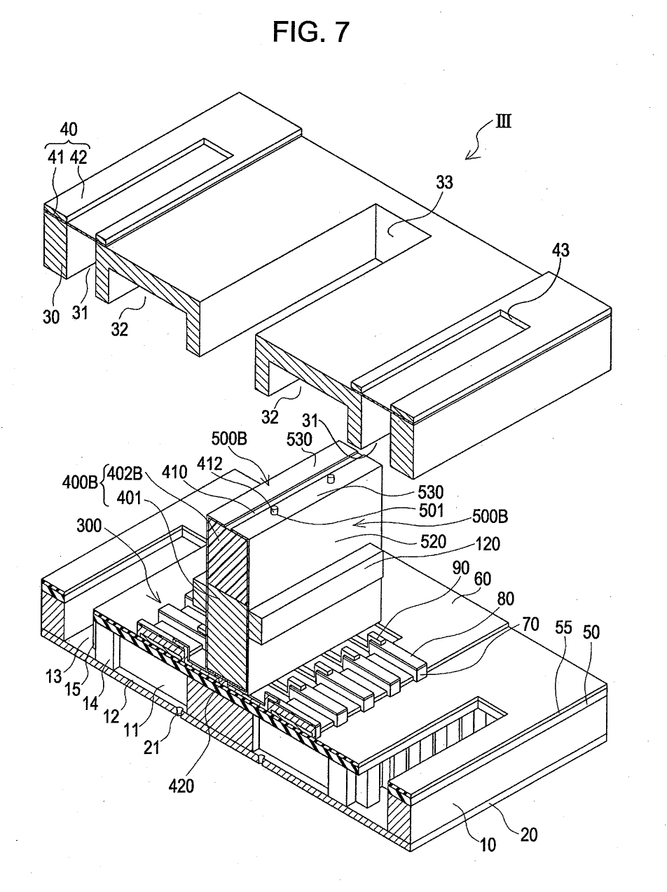

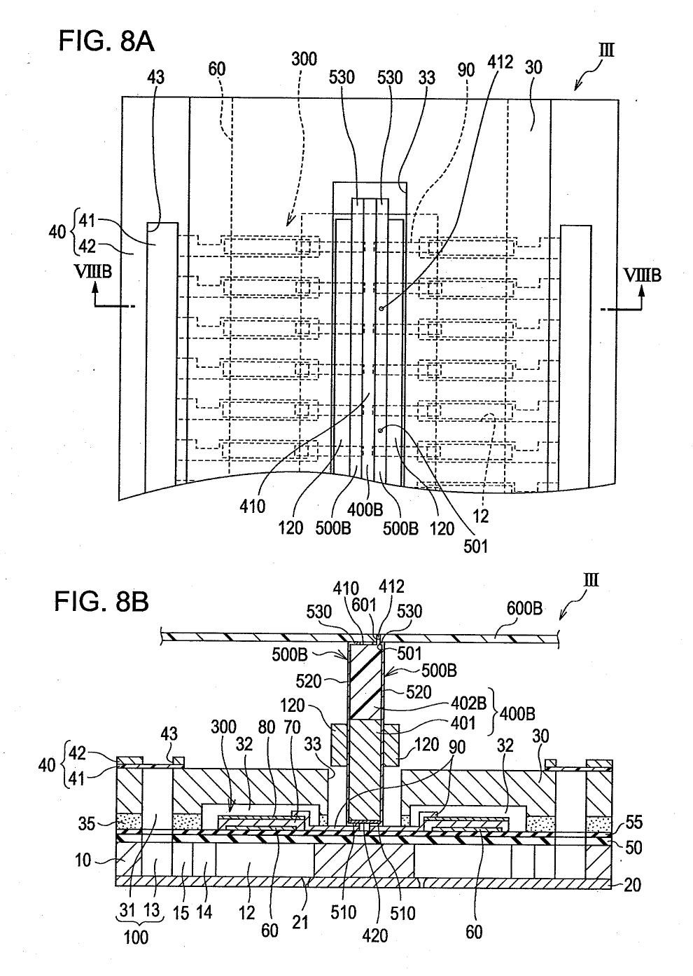

FIG. 7 is an exploded perspective view illustrating the ink jet recording head according to a third embodiment of the invention. FIG. 8A is a plan view illustrating the ink jet recording head shown in FIG. 7. FIG. 8B is a cross-sectional view taken along a line VIIIB-VIIIB of FIG. 8A. Further, in FIG. 7, the flexible printed substrate is omitted. The ink jet recording head according to this embodiment shows a modified example with regard to the support unit portion, and the other portions are the same as those in the first embodiment. Here, the same components as those in the first embodiment are designated by the same reference numerals, and the description already given will be omitted.

As shown in the drawing, the support unit 400B of the ink jet recording head III according to this embodiment is provided with the erecting section 401 and the substrate support section 402B. In this embodiment, a positioning convex portion 412 with a predetermined size is provided to protrude from the connection support surface 410, and the positional convex portion 412 is erected and provided on the connection support surface 410 of the substrate support section 402B. Plural positioning convex portions 412 are formed in a pin shape, and arranged at predetermined intervals along the arrangement direction of the piezoelectric elements 300. In addition, the positioning convex portion 412 is provided close to one side surface of the substrate support section 402B in the connection support surface 410. Further, in this embodiment, the positioning convex portion 412 is integrally configured with the substrate support section 402B, but it may be separately configured.

In addition, positioning concave portions 501 and 601, which are configured with through holes passing through in a thickness direction, are respectively provided on the upper end portion 530 of the COF substrate 500B and the flexible printed substrate 600B. The positioning concave portions 501 and 601 are provided so as to respectively pass through the upper end portion 530 of the COF substrate 500B and the flexible printed substrate 600B. The positioning concave portions 501 and 601 are provided to be the same in number as the positioning convex portions 412. The positioning concave portions are provided to overlap with each other, so that the lines corresponding to each other in the COF substrate 500B and the flexible printed substrate 600B overlap. That is, when the positioning concave portions 501 and 601 are provided to overlap with each other, the lines corresponding to each other in the COF substrate 500B and the flexible printed substrate 600B overlap. Then, the positioning convex portions 412 are engaged with the positioning concave portions 501 and 601 provided in this way, and more specifically, inserted into the positioning concave portions 501 and 601, so that the COF substrate 500B and the flexible printed substrate 600B are positioned with respect to the support unit 400B.

In this embodiment, since the COF substrate 500B and the flexible printed substrate 600B are positioned with accuracy using the positioning convex portion 412 and the positioning concave portions 501 and 601, the connection between the COF substrate 500B and the flexible printed substrate 600B can be more favorably and accurately carried out. In addition, only by engaging the positioning convex portion 412 with the positioning concave portions 501 and 601, the respective substrates can be very easily positioned.

Further, in the above-mentioned embodiment, the positioning convex portion 412 and the positioning concave portions 501 and 601 are provided so as to be positioned on the one side surface of the substrate support section 402B in the connection support surface 410. However, the positioning convex portion 412 and the positioning concave portions 501 and 601 may be provided so as to be positioned on both side surfaces of the substrate support section 402B in the connection support surface 410. In addition, the number of the positioning convex portion 412 and the positioning concave portions 501 and 601 may be each provided with two or more, and it is preferable that they be provided with two pieces on both end portions in the arrangement direction of the piezoelectric elements 300 in consideration of errors. Further, for example, the positioning convex portion 412 may be provided separate from the substrate support section 402B, or the shape thereof may be other shapes such as a planar shape, as long as it can be positioned. The positioning concave portions 510 and 601 may also be other shapes such as a notch, a hole which is not passed through, and a recess.

### Fourth Embodiment

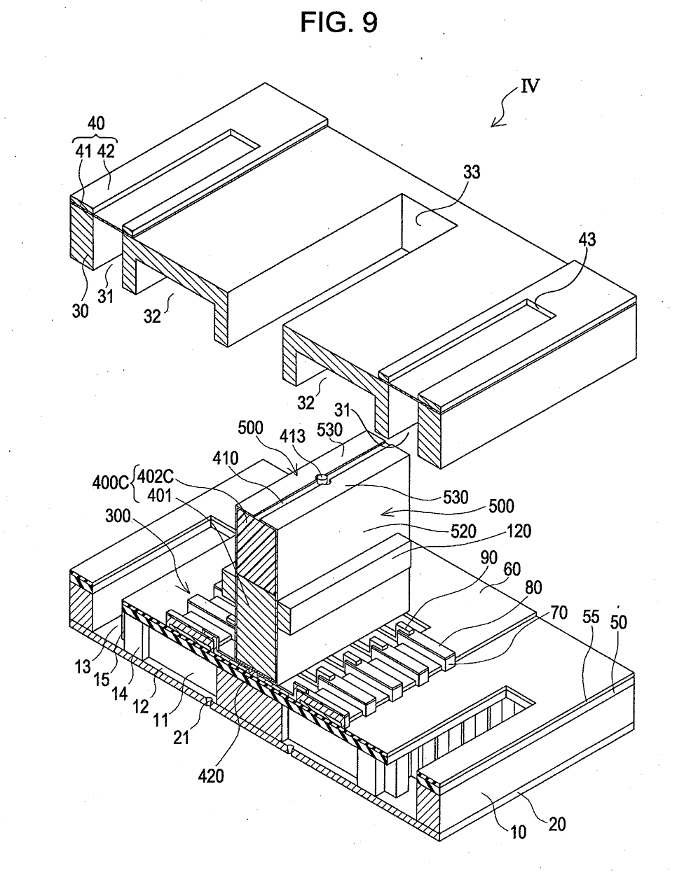

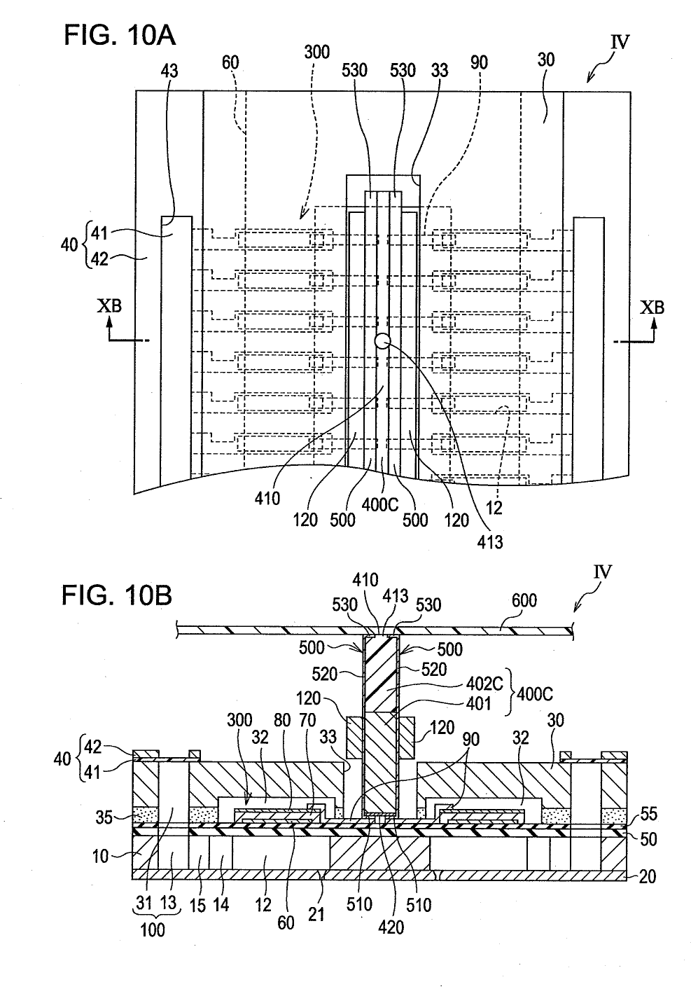

FIG. 9 is an exploded perspective view illustrating the ink jet recording head according to a fourth embodiment of the invention. FIG. 10A is a plan view illustrating the ink jet recording head shown in FIG. 9. FIG. 10B is a cross-sectional view taken along a line XC-XC of FIG. 10A. Further, in FIG. 9, the flexible printed substrate is omitted. The ink jet recording head according to this embodiment shows a modified example with regard to the support unit portion, and the other portions are the same as those in the first embodiment. Here, the same components as those in the first embodiment are designated by the same reference numerals, and the description already given will be omitted.

As shown in the drawing, the support unit 400C of the ink jet recording head IV according to this embodiment is provided with the erecting section 401 and the substrate support section 402C. In this embodiment, a boss portion 413 protrudes from the connection support surface 410. The boss portion 413 is provided on a substantially center portion of the connection support surface 410 of the substrate support section 402C of the support unit 400C in the width direction. Here, the boss portion 413 according to this embodiment is integrally provided with the substrate support section 402C, but it may be separately provided. In addition, the boss portion 413 protrudes from the connection support surface 410 by the height equal to the thickness of the COF substrate 500, and exposed from the upper end portion 530 of the COF substrate 500. That is, the upper end portion 530 of the COF substrate 500 is provided so as to not face the boss portion 413.

In this embodiment, since the boss portion 413 is provided, the boss portion 413 is used such that force is applied to the boss portion 413, so that the support unit 400C can be erected on the fluid channel formation substrate 10 without contact with the COF substrate 500, and it can reliably prevent the COF substrate 500 from being damaged. That is, the boss portion 413 is pushed to the fluid channel formation substrate 10, and the support unit 400C and the COF substrate 500 are erected and provided on the lead electrode 90, so that the support unit 400C can be erected and provided without contact with the COF substrate 500.

Further, in this embodiment, the height of the boss portion 413 is formed to be equal to the thickness of the COF substrate 500. However, the height of the boss portion 413 may be higher or smaller than the thickness of the COF substrate 500 as long as there is no interference with the flexible printed substrate 600, for example, by providing a hole in the flexible printed substrate 600. In addition, the position and the number of the bosses 413 are not particularly limited.

### Another Embodiment

Hereinbefore, the respective embodiments of the invention have been described, the invention including the fluid channel structure, the material, or the like is not limited to the above-mentioned embodiments.

For example, in the above-mentioned embodiments, the pressure generating chambers 12 are provided in two columns parallel to each other in the fluid channel formation substrate 10, and the number of the columns are not particularly limited. The number of the columns may be one or three or more. When the number of the columns is two or more, it is preferable that the columns be arranged to face each other as a set of two columns at least.

In the above-mentioned embodiments, the COF substrates 500 (500B) are provided on both side surfaces of the support unit 400 (400A, 400B, and 400C) one by one, but the invention is not particularly limited. For example, the COF substrate 500 (500B) may be provided on only one side surface of the support unit 400 (400A, 400B, and 400C). In addition, one COF substrate 500 (500B) may be used over both side surfaces of the support unit 400 (400A, 400B, and 400C).

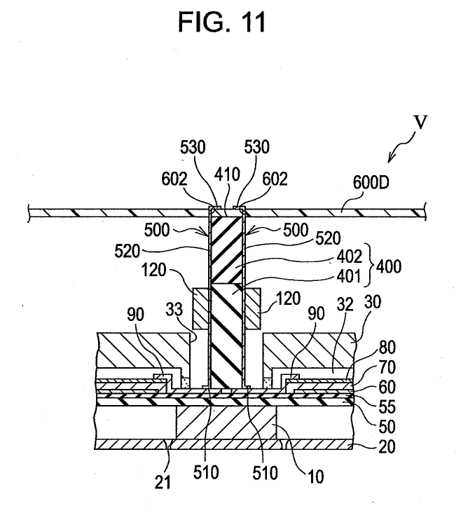

In the above-mentioned embodiments, the lower end portions 510 of the COF substrates 500 (500B) are bent in the direction toward the surface of the erecting section 401 facing the fluid channel formation substrate 10. As shown in FIG. 11, the lower end portions 510 of the COF substrates 500 (500B) may be configured to be bent toward the piezoelectric elements 300 corresponding thereto. FIG. 11 is an enlarged cross-sectional view illustrating a part of the ink jet recording head according to another embodiment of the invention.

In the ink jet recording head V shown in FIG. 11, as described above, the lower end portions 510 of the COF substrates 500 are bent toward the piezoelectric elements 300 corresponding thereto and connected to the lead electrodes 90 in a state where the surface on which the lines of the COF substrate 500 are provided faces the support unit 400. Further, in this case of the configuration, since the surfaces of the COF substrates 500 with the lines face the support unit 400, the material of the support unit 400 needs to be an insulating material in order to prevent short circuits. In addition, through holes 602 are provided on a portion of the flexible printed substrate 600D facing the connection support surface 410 of the substrate support section 402 of the support unit 400, which pass through the flexible printed substrate 600D in the thickness direction. Two through holes 602 are provided in correspondence with the COF substrate 500. Then, the upper end portions 530 of the COF substrates 500 are inserted into these through holes 602 and bent in the direction facing the connection support surface 410, and connected to the flexible printed substrate 600D. Further, the lines are provided on the surface of the flexible printed substrate 600D opposite to the fluid channel formation substrate 10. Only in this configuration, the unique operations and effects of the invention can be achieved. Further, when the lower end portions 510 of the COF substrates 500 are not bent in the direction toward the surface of the erecting section 401 facing the fluid channel formation substrate 10, the erecting section 401 may be integrally configured, for example, with the fluid channel formation substrate 10, the elastic film 50, the insulator film 55, or the like. That is, there is no need for the erecting section 401 of the support unit 400 (400A, 400B, and 400C) to be separately provided from the members of the fluid channel, such as the fluid channel formation substrate 10, the elastic film 50, or the insulator film 55.

In the above-mentioned embodiments, the erecting section 401 and the substrate support section 402 (402A, 402B, and 402C) are formed in a plate shape, but the shape is not particularly limited. For example, the shape may be a raft shape or a lattice shape. The cross section of the piezoelectric element 300 in the longitudinal direction may be an I shape or a trapezoidal shape in which the side of the fluid channel formation substrate is long. Further, when the shape is one different from the planar shape, there is some concern that the COF substrate 500 (500B) may be widened in an area direction of the head and the head may increase in size, but the unique operations and effects of the invention can be achieved. In addition, the support unit 400 (400A, 400B, and 400C) may be provided with another member different from the erecting section and the substrate support section. The number of members constituting the support unit 400 (400A, 400B, and 400C) may be arbitrary as long as it is two or more. Furthermore, these materials are not particularly limited, the materials may be all the same or different from each other, or various materials such as metal or resin can be employed.

In the above-mentioned embodiments, the COF substrate 500 (500B) which is a flexible printed substrate is used as a first substrate on which the lines are provided. In addition, the flexible printed substrate 600 (600B and 600D) is used as a second substrate on which the same lines are provided. However, the configuration of the invention is not limited thereto. For example, a rigid substrate with low flexibility may be employed as the first substrate and the second substrate.

In the above-mentioned embodiments, the connection support surface 410 is provided parallel to the surface direction of the fluid channel formation substrate 10. It is a matter of course that the connection support surface 410 may be slightly inclined with respect to the fluid channel formation substrate 10.

In the above-mentioned embodiments, the actuator device having the thin-film piezoelectric element 300 is employed as the pressure generating element which causes pressure change in the pressure generating chamber 12, but the invention is not particularly limited thereto. For example, there may be used a thick-film actuator device which is formed by a method of attaching a green sheet, or a longitudinal oscillation type actuator device in which the piezoelectric material and the electrode forming material are alternatively laminated and stretched in an axis direction. In addition, as the pressure generating element, there may be used an element in which heater elements are disposed in the pressure generating chamber and liquid droplets are ejected from the nozzle opening due to bubbles generated by heat of the heater elements, or a so-called electrostatic actuator in which static electricity is generated between the oscillation plate and the electrode and thereby the oscillation plate is deformed by the generated electrostatic force so as to eject liquid droplets from the nozzle openings. Further, when the pressure generating element is used, the lead electrode 90 may not be provided in some cases. Of course, the invention can be applied to the configuration in which the lead electrode 90 is not equipped.

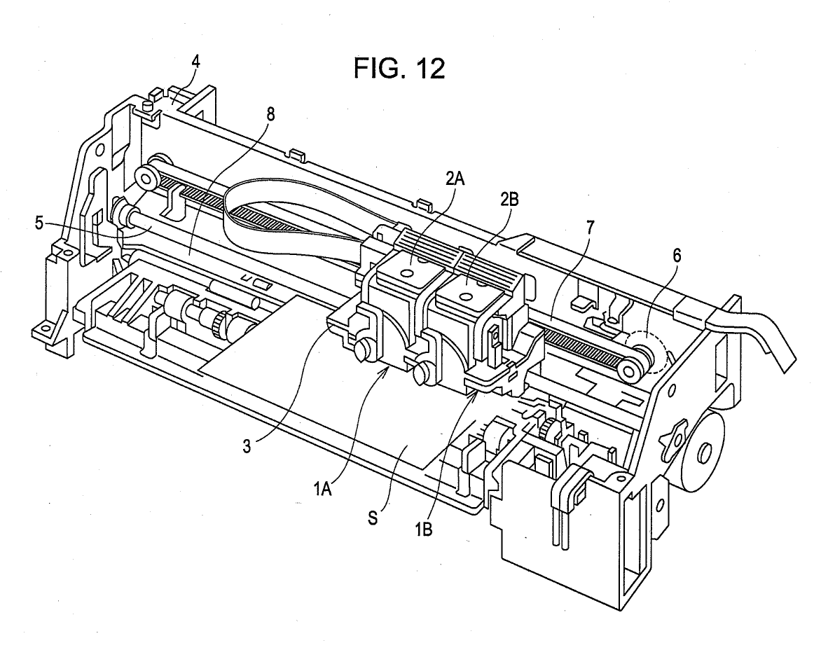

The ink jet recording heads I, II, III, IV, and V according to the above-mentioned embodiments configure a part of the recording head unit which is provided with the ink flow channel communicating with an ink cartridge, and mounted on the ink jet recording apparatus. FIG. 12 is a schematic view illustrating an example of the ink jet recording apparatus. As shown in the drawing, the recording head units 1A and 1B, which include the ink jet recording heads I, II, III, IV, and V according to the above-mentioned embodiments, are provided with cartridges 2A and 2B constituting the ink supply means which can be mounted thereon or demounted therefrom. Carriage 3, on which the recording head units 1A and 1B are mounted, is provided at carriage shaft 5 so as to freely move in an axis direction. The carriage shaft 5 is attached to an apparatus body 4. For example, the recording head units 1A and 1B each eject a black ink composition and a color ink composition.

A driving force of a driving motor 6 is transferred to the carriage 3 via plural toothed wheels (not shown) and a timing belt 7, so that the carriage 3 on which the recording head units 1A and 1B are mounted moves along the carriage shaft 5. On the other hand, a platen 8 is provided along the carriage shaft 5 in the apparatus body 4. A recording sheet S which is a recording medium such as paper supplied by a paper feeding roller (not shown) is rolled up to the platen 8 so as to be transported.

In the above-mentioned embodiments, the ink jet recording head has been exemplified as an example of the liquid ejecting head. However, the invention widely relates to a general liquid ejecting head, and can be applied also to a liquid ejecting head which ejects liquid other than the ink. As the other liquid ejecting head, for example, various recording heads which are used to an image recorder such as a printer, a coloring material ejecting head which is used to manufacture color filters such as a liquid crystal display, an electrode material ejecting head which is used to form electrodes of an organic EL display, a field emission display (FED), or the like, and a biological organic material ejecting head which is used to manufacture bio chips are exemplified.

What is claimed is:

1. A liquid ejecting head comprising:
a fluid channel formation substrate in which a fluid channel is formed so as to be communicated to a nozzle opening for ejecting liquid;
a pressure generating element which applies pressure on the liquid to be ejected;
a first substrate of which one end is electrically connected to the pressure generating element;
a second substrate which is connected to the other end of the first substrate; and
a support unit which supports the first substrate,
wherein the support unit includes an erecting section which is provided on the one end of the first substrate, and a substrate support section which is provided on a side of the erecting section facing the second substrate and is formed of a separate member from the erecting section,
wherein the substrate support section includes a connection support surface on a side thereof facing the second substrate, and
wherein a connection portion between the first substrate and the second substrate is disposed on a position facing the connection support surface.

2. The liquid ejecting head according to claim 1, further comprising: a connection line which is electrically connected to the pressure generating element and connected to one end of the first substrate,
wherein the support unit is provided on a position facing a connection portion between the first substrate and the connection line.

3. The liquid ejecting head according to claim 1,
wherein an area of the connection support surface is larger than that of a surface of the erecting section facing the fluid channel formation substrate.

4. The liquid ejecting head according to claim 1,
wherein positioning convex portions are provided on the connection support surface,
wherein positioning concave portions are respectively provided on the first substrate and the second substrate, and
wherein the positioning convex portions and the positioning concave portions are engaged with each other, so that the first substrate and the second substrate are positioned with respect to the support unit.

5. The liquid ejecting head according to claim 1,
wherein a boss portion is provided on the connection support surface so as to protrude from the connection support surface.

6. The liquid ejecting head according to claim 1,
wherein the erecting section and the substrate support section are plate-like members, and
wherein the first substrate is supported along the support unit.

7. A liquid ejecting apparatus comprising the liquid ejecting head according to claim 1.
